(19) United States
(12) Patent Application Publication
(10) Pub. No.: US 2011/0213662 A1
(43) Pub. Date: Sep. 1, 2011

(54) Mechanism for Generating Banner Advertisements in a Printer System

(76) Inventors: Robert Frederic Jessen, Berthoud, CO (US); Kristin Reischel, Greeley, CO (US)

(21) Appl. No.: 12/713,384

(22) Filed: Feb. 26, 2010

(51) Int. Cl. G06Q 30/00

(52) U.S. Cl. 705/14.53; 705/14.4; 705/14.49; 705/14.61; 705/14.66

(57) ABSTRACT

A printing system is disclosed. The printing system includes a display page system having a storage device to store content for banner messages to be included in banner advertisements and a page generator to select one or more banner messages from the stored content upon detecting a trigger event and generate a banner advertisement that includes the selected banner messages. The printing system also includes a user interface having a display component to display the banner advertisement.

### FIELD OF THE INVENTION

The invention relates to the field of printing systems, and in particular, to items displayed at a printing system.

### BACKGROUND

The popularity of workgroup printers that have graphical user interface (GUI) displays are increasing. These displays often support more complex data such as image files, color graphics, and touch screen controls that act as entry points to device functions. However, the use of such displays is not maximized since irrelevant data is often displayed while a user is interacting with a printer.

A web banner advertisement or web banner is a form of advertising in which an advertisement is embedded into a web page that is viewed at a display device. When the viewer clicks on the banner, the viewer is directed to the website advertised in the banner. Thus, web banners function the same way as traditional advertisements are intended to function (e.g., notifying consumers of the product or service and presenting reasons why the consumer should choose the product in question), although web banners differ in that the results for advertisement campaigns may be monitored real-time and may be targeted to the viewer's interests.

Since the use of displays at printers is not maximized, it would be desirable to display banner advertisements at a printing system.

### SUMMARY

In one embodiment a printing system is disclosed. The printing system includes a display page system having a storage device to store content for banner messages to be included in banner advertisements and a page generator to select one or more banner messages from the stored content upon detecting a trigger event and generate a banner advertisement that includes the selected banner messages. The printing system also includes a user interface having a display component to display the banner advertisement.

In another embodiment, a method discloses detecting a trigger event at a printing system, selecting one or more banner messages upon detecting the trigger event, generating a banner advertisement including the selected banner messages and displaying the banner advertisement at a display component at the printing system.

In yet another embodiment, a multifunction printer is disclosed. The multifunction printer includes a user interface having an input component and a display component. The multifunction printer further includes a controller to select one or more banner messages from stored content upon detecting activity at the input component and generate a banner advertisement that includes the selected banner messages to be displayed at the display component.

### BRIEF DESCRIPTION OF THE DRAWINGS

A better understanding of the present invention can be obtained from the following detailed description in conjunction with the following drawings, in which:

FIG. 1 illustrates one embodiment of a printing system;

FIG. 2 illustrates one embodiment of a display page system;

FIG. 3 is a flow diagram illustrating one embodiment of generating of banner advertisements within a printing system;

FIG. 4 illustrates one embodiment of a banner ad;

FIG. 5 illustrates another embodiment of a banner ad;

FIG. 6 is a flow diagram illustrating one embodiment of tracking content; and

FIG. 7 illustrates one embodiment of a computer system.

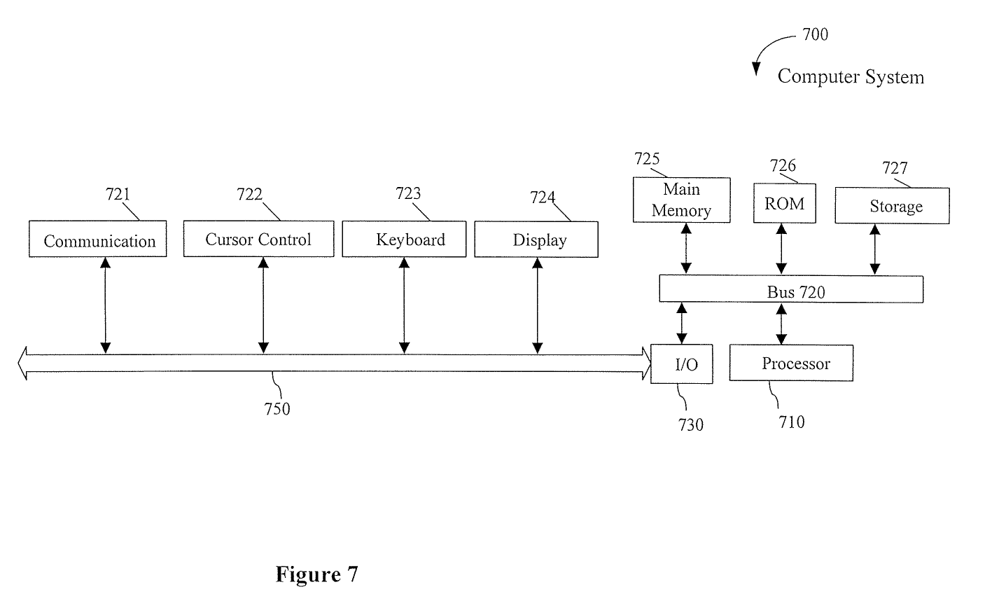

### DETAILED DESCRIPTION

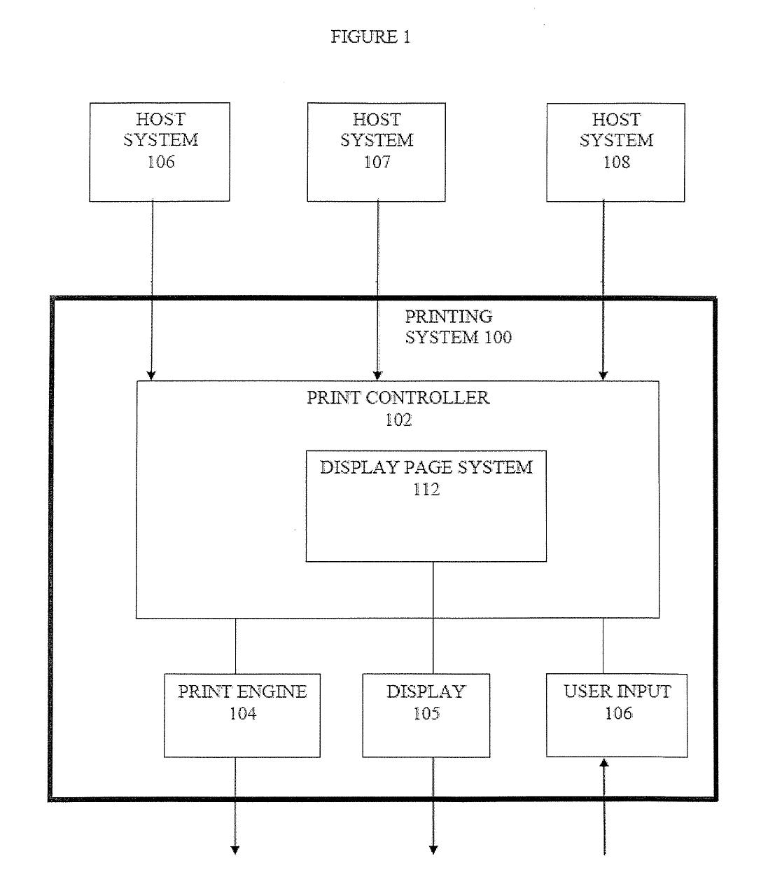

FIG. 1 is a block diagram illustrating one embodiment of a printing system 100. Printing system 100 is a system used to provide marks on a media, such as a continuous forms printer or a cut sheet page printer. Printing system 100 may include any digital hardcopy output device, such as printers, copiers, multifunction printers (MFP's) and facsimiles. In one embodiment, printing system 100 is shared by multiple users. In such an embodiment, printing system 100 includes a print controller 102 and one or more print engines 104. Print controller 102 includes any system, server, or components operable to interface one or more host systems 106-108 with one or more print engines 104, and to control the printing of print jobs received from the host systems 106-108 on print engine 104. Print engine 104 provides an imaging process to mark a printable medium, such as paper.

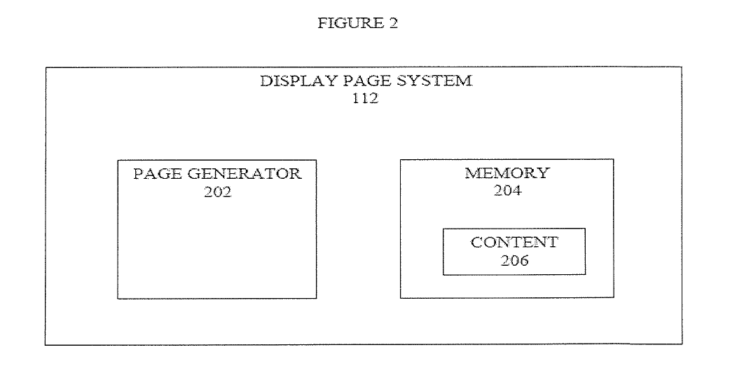

According to one embodiment, print controller 102 includes a display page system 112 that defines and generates banner advertisements to be presented at display 105. In other embodiments, printing system 100 may include multiple displays 105 on which banner advertisements may be presented. FIG. 2 illustrates one embodiment of display page system 112. Display page system 112 includes a page generator 202 and memory 204. Page generator 202 generates one or more banner advertisements that are displayed at display 105. In a further embodiment, page generator 202 generates customized banner advertisements upon receiving a trigger event, as will be discussed in further detail below. Memory 204 comprises any storage system operable to store content 206 representing selectable banner messages for banner advertisements.

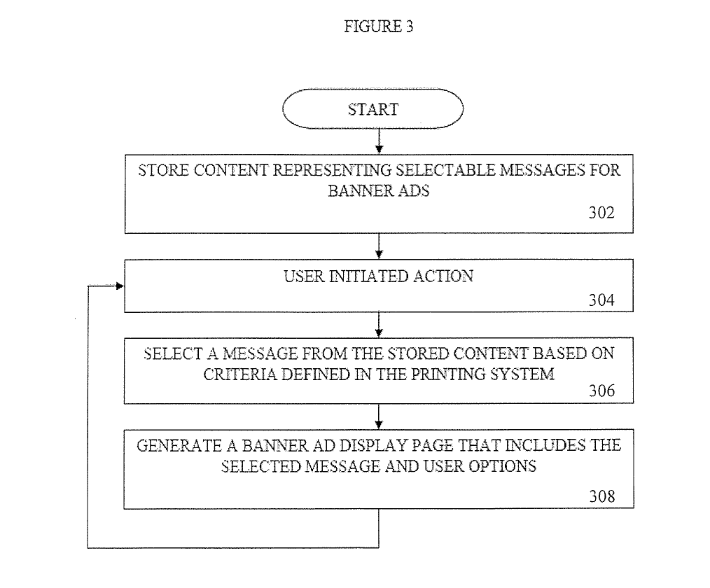

FIG. 3 is a flow diagram illustrating one embodiment of generating banner advertisements at display page generator 202. At processing block 302, memory 204 stores content 206 representing selectable banner messages for banner advertisements. Content 206 may include images, text, digital pictures, bar codes, or any other data that may be selected for a banner message. In one embodiment, content 206 may be supplied or provided by a third party (e.g., other than the owner of printing system 100) and stored in memory 204. For example, content 206 of a third party may include advertisements, coupons, notifications, etc. Content 206 is separate from print job data that may be received into printing system 100.

At processing block 304, page generator 202 detects user interaction (or trigger event) at user input 106. In one embodiment, the trigger event may include authentication (e.g., login), selecting held print jobs, selecting held fax job, selecting copy menu, etc. at user input 106. Other trigger mechanisms may include print job receipt, fax job receipt, machine error or sleep mode. However in such embodiments, no user may be at the machine to view a message.

At processing block 306, page generator 202 defines a banner advertisement by selecting one or more banner messages from content 206 stored in memory 204 based on criteria defined in printing system 100 for each trigger event. The banner message may include text, an image, a digital picture, or any other data that communicates information.

The criteria may include rules or algorithms that define a banner message to select from the stored content 206. According to one embodiment, the criteria are pre-defined before a trigger event is received, and may be modified as desired. The criteria may include rules that select a banner message without any variables. For example, page generator 202 may select the banner message randomly from the stored content based on the criteria.

The criteria may alternatively include rules that act on one or more variables. For example, page generator 202 may select the banner message based on the criteria and metadata from the print job, such as the number of copies, the number of pages, duplex printing, n-up printing, a user name, a file name, etc. Page generator 202 may select the banner message based on the criteria and a time of day, day of the week, year, season, etc. Further, page generator 202 may select the banner message based on the criteria and a usage history of a user that sent the print job, such as the number of pages the user has printed on printing system 100 during a time period.

In another embodiment, page generator 202 may select the banner message based on the criteria and a device state of printing system 100, such as a consumable supplies condition, error message, error log, readiness, etc. Page generator 202 may also select the banner message based on the criteria and print job resource information, such as the number of sheets in the print job, the ink or toner coverage used in the print job, or other resources of printing system 100 that are used to print the job. Page generator 202 may select the banner message based on the criteria and printer settings, such as enabled printer input or output features, operator panel language, or media selected.

In a further embodiment, page generator 202 may select the banner message based on the criteria and user identification (e.g., user inputted name, authenticated user, group name, etc.). Page generator 202 may further select the banner message based on the criteria and an action selected by a user (e.g., print held jobs, copy, fax, scan, email, etc.). In such an embodiment, a banner advertisement could include timely company wide information (e.g., bulletin board information) on internal or external products, services, events, news or initiatives. For instance, the banner advertisement could display an hourly stock quotation or timely reminders for company events to employees.

In another embodiment, the banner advertisement may include end user specific information targeted to an end user about their location, print date/time, printing history, job set-up or other print options. For example, the banner may display “Attention user Smith, You have printed 136 documents this month in this printer. Please consider reducing the amount you print to help the planet” or “Attention user Smith, This print job was printed in simplex. Next time, please consider using duplex to save paper.”

In yet another embodiment, an end user's monthly page count for the printer is listed and compared to the corporate target monthly user page count. The displayed banner advertisement may include the user's monthly page count, the corporate target monthly page count and an admonishment message if the user is over the target. In still another embodiment, a restaurant dinner advertisement is placed on the banner advertisement for all print jobs printed after 4:30 pm.

In a further embodiment, an algorithm may determine a coupon that displays on the banner ad, where a coupon code is part of the information displayed and can be redeemed. A set of coupons may be stored on printing system 100 or memory at a host. An algorithm selects one or more coupons from the set. The algorithm may include allotting how many of each coupon the end user will receive displayed and when in a time period. To generate a physical copy of the coupon, the user may select to print the desired coupon. Printing system 100 then prints the coupon. The coupon may include a unique bar code to help control the number of coupons redeemed for each user.

In another embodiment, a banner advertisement is generated using printer state information. For example, if the printer toner is low a message to order more toner is placed on the banner advertisement. Further, printer settings information may be used to provide the banner advertisement information in other languages (e.g., Spanish, French, Arabic, etc.) based on the printer's operator panel language. In still another embodiment, banner advertisements may include management approved bulletin board items. For example, an employee bike to work day event message may be set to appear on banner advertisements displayed within a range of calendar dates leading up to the event.

In one embodiment, a banner advertisement is displayed as a confidential data label for print jobs labeled confidential in order to alert the end user to the confidentiality. Additionally, publicly used copiers could display messages that are relevant for a specific user demographic. For example, a college book store may sponsor a warning message that could be displayed on a publicly used copier discouraging copyright infringement. As discussed herein, banner messages may be generated based on countless user actions.

In addition to selecting the banner message in processing block 306, page generator 202 may transform or modify the banner message in some manner. In one embodiment, printing system 100 or a host may encode data into the banner advertisement. For example, a unique redemption code may be placed on the banner advertisement to aid billing or tracking the usage of the coupon. The unique code may include a date, end user name, machine serial number or other identifying information.

In another embodiment where a selected banner message includes an advertisement with an expiration date of two weeks, page generator 202 may calculate the actual expiration date for the advertisement based on a present date/time, and modify the banner message to indicate the actual expiration date. In yet another embodiment, the banner advertisement may display a full end user name by translating a cryptic print job user name or authenticated log in name to a full name (e.g. “ZSMITH2” is replaced with “Zingo Smith”). This translation may be aided with the use of a pre-defined name cross-reference table.

According to one embodiment, page generator 202 may also add user selectable choices to a banner advertisement and generate additional banner advertisements linked to the user selectable choices. In such an embodiment, a banner message may be displayed as a result of a user selecting a previously displayed banner message prompt. Thus, the banner advertisement enables user interaction such that the user may skip the displayed message, get additional displayed information or print additional information.

For example, a user is prompted to select from several sponsor offers. The selection either displays more details on the offer or prints a hardcopy of the offer (e.g. a coupon). In another example, a user can select an option to display additional information stored on the printer, resulting in the selection of a link to the World Wide Web or network to retrieve the additional information. In such an example, a user may select a banner advertisement that then pulls and displays the stock value from a predefined World Wide Web site.

Referring back to FIG. 3, page generator 202 generates a banner advertisement display page that includes the selected banner message at processing block 308. The format of the banner advertisement may be pre-defined according to one or more templates defined in printing system 100. Also, page generator 202 may select a format of the banner advertisement based on the criteria. For example, page generator 202 may select the format of the banner advertisement based on the criteria and metadata from the print job, time of day, day of the week, year, season, usage history of the originator of the print job, a device state of printing system 100, etc. Thus, the format of the banner advertisement may also be selected for each trigger event, and may be added as an additional process.

Processing blocks 306 and 308 are performed for each trigger event that occurs. Thus, page generator 202 selects a banner message from the stored content 206 per trigger event. Page generator 202 does not merely identify text or an image that is globally used for all print jobs that are received in printing system 100, such as a company logo. Page generator 202 selects a banner message for each individual trigger event. This means that the banner messages selected for each trigger event may be different. However, those skilled in the art will appreciate that the same banner message may be selected for multiple trigger event depending on the criteria.

Control of the banner advertisement content and format may be through printing system 100, host control or a combination of the two. Combination of printing system 100 and host control may be implemented by a division of responsibility between the host and printing system 100. For example, a banner advertisement template may be sent from the host and the printer fills in the variable data or vice versa. Settings on the printing system 100 or host are configurable locally or remotely.

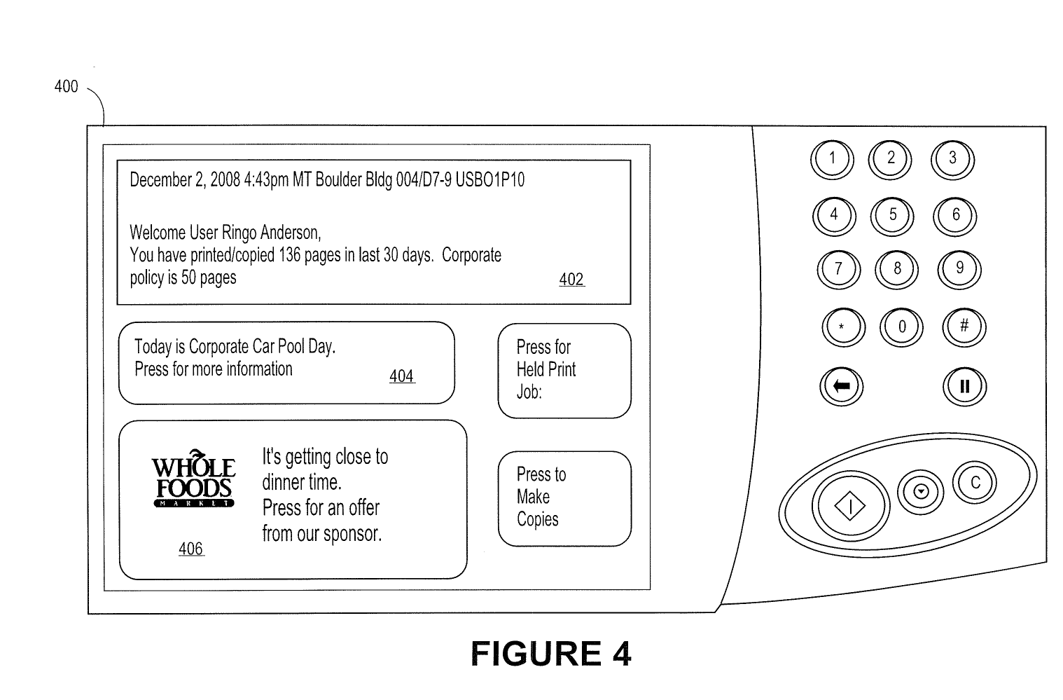

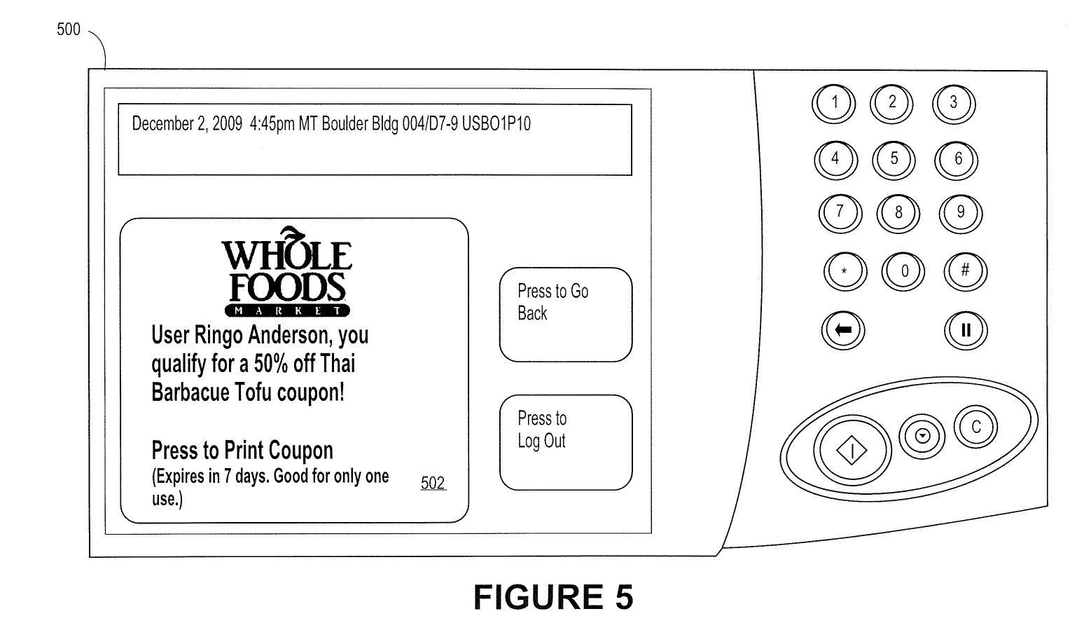

FIGS. 4 and 5 illustrate embodiments of banner advertisements 146-148. FIG. 4 illustrates a banner advertisement 400 including banner messages 402, 404 and 406. Banner message 402 is user specific message including a notice from the company targeted to a user (Ringo Anderson). Display page system 112 selects this notice based on criteria. In this example, display page system 112 may process the criteria, the past usage history of “Anderson”, to select the notice. For instance, display page system 112 determines that Anderson has printed 136 pages over the last 30 days. Thus, display page system 112 selects a notice from the company indicating the target number of sheets (50) for Anderson.

Message 404 is a management bulletin board item selected by display page system 112 based on a calendared event (car pool day). Banner message 406 is an advertisement for a grocery store (Whole Foods). Display page system 112 selects this advertisement based on the criteria defined within printing system 100. In this example, display page system 112 may process the criteria and the time of day, which is after 4:00 p.m., to identify an advertisement for a dinner special at Whole Foods.

FIG. 5 illustrates a banner advertisement 500 including banner message 502. Banner message 502 is a coupon message for a store (Whole Foods) that is selected based on the criteria. In this example, display page system 112 may process the criteria and the date, which is December 2, to identify a coupon for Whole Foods. Note that banner message 502 may be a result of the user selecting banner message 406 shown in FIG. 4.

The user may print the coupon by selecting message 502. Those skilled in the art will appreciate that display page system 112 may select other stored content to include in the banner message 502.

FIGS. 4 and 5 show that display page system 112 may select a variety of banner messages to include in the banner advertisements 400 and 500 based on the criteria stored in printing system 100. Display page system 112 selects additional content that is stored in printing system 100, and includes the additional content in the banner advertisements. The additional content may advantageously include notifications from the company, or may comprise advertisements from third parties that can generate extra revenue for the company.

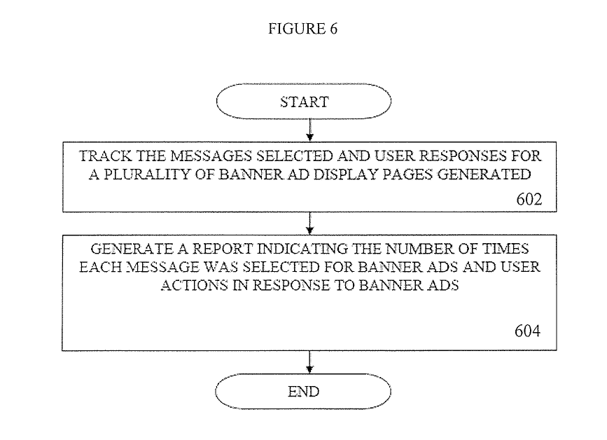

Because content 206 for the banner messages may be for a third party, such as an advertiser, it may be advantageous to track what content 206 is being used in the banner advertisements that are printed. FIG. 6 is a flow diagram illustrating one embodiment of tracking content included in banner advertisements. At processing block 602, page generator 202 tracks the banner messages selected for display as banner advertisements. For example, assuming that stored content 206 includes ten advertisements, page generator 202 counts the number of times each advertisement is included as a banner message in a banner advertisement. In a further embodiment, page generator 202 tracks the user responses to each of the banner messages.

At processing block 604, page generator 202 generates a report indicating the number of times each banner message was selected for the banner advertisements and/or user actions in response to the advertisements. The report may further include tracking time duration, dates and times of each occurrence of the banner messages, user names associated with each banner message, etc. The report may comprise a human-readable format or raw data that may be processed by a computing system or server.

In one embodiment, the report is made available to a host or other devices through various existing means (e.g. TCP/IP, FTP, HTTP, SNMP, email, etc) via various conduits and protocols (e.g. WAN, LAN, PC Serial, PC Parallel, IEEE1394, USB, 802.11x, etc.). Further, the information may be printed at print engine 104, displayed at display 105 or available from the printer's web page. After the report is generated, page generator 202 may send the report to the third party or a third party system for billing or confirmation to the third party as to what content is being provided to the users of printing system 100.

Printing system 100 may also include configuration settings for configuring banner advertisement settings. In such an embodiment, data and algorithms could be added locally or remotely through the network with a variety of established methods. Table 1 below is an exemplary printer configuration settings menu.

TABLE 1

Banner Ad Configuration Menu

Enable Banner Ads

Yes
No

Enable Banner Ad Tracking

Yes
No

Banner Ad Number 1

Content Criteria

1
2
N

Format Criteria

1
2
N

Display Location

1
2
N

Banner Ad Number N

Content Criteria

1
2
N

Format Criteria

1
2
N

Display Location

1
2
N

FIG. 6 illustrates a computer system 700 on which hosts 106-108 and/or printing system 100 may be implemented. Computer system 700 includes a system bus 720 for communicating information, and a processor 710 coupled to bus 720 for processing information.

Computer system 700 further comprises a random access memory (RAM) or other dynamic storage device 725 (referred to herein as main memory), coupled to bus 720 for storing information and instructions to be executed by processor 710. Main memory 725 also may be used for storing temporary variables or other intermediate information during execution of instructions by processor 710. Computer system 700 also may include a read only memory (ROM) and or other static storage device 726 coupled to bus 720 for storing static information and instructions used by processor 710.

A data storage device 625 such as a magnetic disk or optical disc and its corresponding drive may also be coupled to computer system 600 for storing information and instructions. Computer system 600 can also be coupled to a second I/O bus 750 via an I/O interface 730. A plurality of I/O devices may be coupled to I/O bus 750, including a display device 724, an input device (e.g., an alphanumeric input device 723 and or a cursor control device 722). The communication device 721 is for accessing other computers (servers or clients). The communication device 721 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

1. A printing system comprising:
a display page system, including:
a storage device to store content for banner messages to be included in banner advertisements; and
a page generator to select one or more banner messages from the stored content upon detecting a trigger event and generate a banner advertisement that includes the selected banner messages; and
a user interface having a display component to display the banner advertisement.

2. The printing system of claim 1 wherein the page generator selects the one or more banner messages from the stored content based on pre-defined criteria.

3. The printing system of claim 2 wherein the page generator selects the one or more banner messages from the stored content based on the pre-defined criteria and a time.

4. The printing system of claim 2 wherein the page generator selects the one or more banner messages from the stored content based on the pre-defined criteria and a usage history of a user.

5. The printing system of claim 2 wherein the page generator selects the one or more banner messages from the stored content based on the pre-defined criteria and a state of the printing system.

6. The printing system of claim 2 wherein the page generator selects the one or more banner messages from the stored content based on the pre-defined criteria and settings of the printing system.

7. The printing system of claim 2 wherein the user interface further comprises an input component.

8. The printing system of claim 7 wherein the page generator selects the one or more banner messages from the stored content based on the pre-defined criteria and a user identification entered at the input component.

9. The printing system of claim 7 wherein the page generator selects the one or more banner messages from the stored content based on the pre-defined criteria and an action selected by the user at the input component.

10. The printing system of claim 1 wherein the page generator tracks the one or more banner messages selected and displayed in banner advertisements.

11. The printing system of claim 10 wherein the page generator further tracks responses to the displayed banner advertisements.

12. The printing system of claim 11 wherein the page generator generates a report indicating a number of times each banner message was selected for the banner advertisements and responses to the banner advertisements.

13. A method comprising:
detecting a trigger event at a printing system;
selecting one or more banner messages upon detecting the trigger event;
generating a banner advertisement including the selected banner messages; and
displaying the banner advertisement at a display component at the printing system.

14. The method of claim 13 further comprising storing content representing selectable banner messages for banner advertisements in the printing system.

15. The method of claim 13 wherein the trigger event comprises activity at an input component.

16. The method of claim 15 wherein selecting the one or more banner messages comprises selecting a banner message based on pre-defined criteria and a user identification entered at the input component.

17. The method of claim 15 wherein selecting the one or more banner messages comprises selecting a banner message based on pre-defined criteria and an action selected by the user at the input component.

18. The method of claim 13 further comprising tracking the one or more banner messages selected and displayed in banner advertisements.

19. The printing system of claim 18 further comprising tracking responses to the displayed banner advertisements.

20. The printing system of claim 19 further comprising generating a report indicating a number of times each banner message was selected for the banner advertisements and responses to the banner advertisements.

21. A multifunction printer comprising:
a user interface, including:
an input component; and
a display component; and
a controller to select one or more banner messages from stored content upon detecting activity at the input component and generate a banner advertisement that includes the selected banner messages to be displayed at the display component.

22. The printer of claim 21 wherein the controller selects the one or more banner messages from the stored content based on pre-defined criteria.

23. The printer of claim 22 wherein the controller selects the one or more banner messages from the stored content based on the pre-defined criteria and a user identification entered at the input component.

24. The printer of claim 22 wherein the controller selects the one or more banner messages from the stored content based on the pre-defined criteria and an action selected by the user at the input component.

25. The printer of claim 21 wherein the controller tracks the one or more banner messages selected and displayed in banner advertisements and responses to the displayed banner advertisements.

26. The printer of claim 25 wherein the controller generates a report indicating a number of times each banner message was selected for the banner advertisements and responses to the banner advertisements.

27. The printer of claim 21 wherein the controller selects a format of the one or more banner messages based on pre-defined criteria.

28. The printer of claim 21 wherein the controller page generator 202 transforms a banner message.

29. An article of manufacture comprising a machine-readable medium including data that, when accessed by a machine, cause the machine to perform operations comprising:
detecting a trigger event at a printing system;
selecting one or more banner messages upon detecting the trigger event;
generating a banner advertisement including the selected banner messages; and
displaying the banner advertisement at a display component at the printing system.

30. The article of manufacture of claim 29 including data that, when accessed by a machine, cause the machine to further perform operations comprising storing content representing selectable banner messages for banner advertisements in the printing system.

31. The article of manufacture of claim 29 wherein selecting the one or more banner messages comprises selecting a banner message based on pre-defined criteria and a user identification entered at the input component.

32. The article of manufacture of claim 29 wherein selecting the one or more banner messages comprises selecting a banner message based on pre-defined criteria and an action selected by the user at the input component.

33. The article of manufacture of claim 32 including data that, when accessed by a machine, cause the machine to further perform operations comprising tracking the one or more banner messages selected and displayed in banner advertisements.

34. The article of manufacture of claim 33 including data that, when accessed by a machine, cause the machine to further perform operations comprising tracking responses to the displayed banner advertisements.
